(19) United States
(12) Patent Application Publication
(10) Pub. No.: US 2010/0217483 A1
(43) Pub. Date: Aug. 26, 2010

(54) VEHICULAR DRIVING SUPPORT APPARATUS

(75) Inventor: Koji Matsuno, Tokyo (JP)

Correspondence Address: HAYNES AND BOONE, LLP;IP Section, 2323 Victory Avenue, Suite 700, Dallas, TX, 75219, US

(73) Assignee: Fuji Jukogyo Kabushiki Kaisha, Tokyo (JP)

(21) Appl. No.: 12/707,535

(22) Filed: Feb. 17, 2010

(30) Foreign Application Priority Data
Feb. 20, 2009 (JP) 2009-038301

(51) Int. Cl. G08G 1/16

(52) U.S. Cl. 701/36

(57) ABSTRACT

When a vehicle makes a right turn at an intersection, the intersection as a traffic environment around the vehicle, the vehicle and an oncoming vehicle are displayed along with the respective current positions. A traveling track of the right turn of the vehicle and a traveling track of the oncoming vehicle are also displayed using indication arrows. Further, since an icon F is displayed at an intersection of the traveling track of the vehicle and the traveling track of the oncoming vehicle, the driver of the vehicle is easily encouraged to recognize that there is a high possibility of a collision with the oncoming vehicle if the vehicle makes a right turn in this situation, even if the driver of the vehicle does not pay sufficient attention to the oncoming vehicle.

### CROSS-REFERENCE TO RELATED APPLICATIONS

The disclosure of Japanese Patent Application No. 2009-038301 filed on Feb. 20, 2009 including the specification, drawings and abstract is incorporated herein by reference in its entirety.

### BACKGROUND OF THE INVENTION

1. Field of the Invention

The present invention relates to a vehicular driving support apparatus for recognizing an environment around a vehicle and performing a driving support for a driver.

2. Description of Related Art

Recently, regarding a vehicle such as an automobile, technologies have been developed and become a practical application in order to prevent a collision accident of a vehicle and the like and improve safety by recognizing an obstacle or another vehicle existing around the vehicle using information acquired from a onboard camera or a laser radar device or information acquired from a vehicle-to-vehicle communication or a road-to-vehicle communication and the like and executing various driving support controls such as a warning, an automatic brake, an automatic steering or the like.

For example, Japanese Patent Application Laid-Open (JP-A) No. 2006-323876 discloses a technology for accumulating information of at least one of a traveling state of a vehicle and a state of a driver to determine a characteristic of the driver based on the information, predicting a possibility of future accident encountered by the driver based on the determined driver's characteristic and a pre-defined accident involvement rate, and informing the driver of the result.

As disclosed in JP-A No. 2006-323876, predicting a future accident and warning the driver as a driving support may be effective to reduce traffic accidents. Warning and controlling based on a future prediction are needed especially when the driver is not aware of the danger; however, the driver who is not aware of a danger sometimes cannot recognize why the warning and controlling have been given.

Thus, warning and controlling by simply predicting the future may cause mistrust or confusion of the driver and the driving support may not work effectively.

The present invention has been made in view of the above problem and has an object to provide a vehicular driving support apparatus that is capable of informing a predicted future danger to a driver who does not aware of the danger in a manner the driver can easily recognize the danger and is encouraged to drive according to the warning and improving active safety.

### SUMMARY OF THE INVENTION

In order to achieve the object, a vehicular driving support apparatus of the present invention is a vehicular driving support apparatus for recognizing an environment around a vehicle and performing a driving support for a driver, including: a vehicle position prediction unit configured to predict a course of the vehicle and calculate a position of the vehicle on the predicted course; an obstacle detection unit configured to detect an obstacle that may intersect with the predicted course of the vehicle and calculate a position of the obstacle; a collision determination unit configured to determine a possibility of a collision between the vehicle and the obstacle based on the position of the vehicle on the predicted course and the position of the obstacle; and a support control unit configured to, when it is determined that there is a possibility of a collision between the vehicle and the obstacle, output a control signal to inform the driver of at least a predicted collision position where the predicted course of the vehicle le may intersect with the obstacle.

According to the present invention, the driver who is not aware of a danger can easily recognize a predicted future danger and is encouraged to drive according to the warning so that predictive safety performance can be improved.

### BRIEF DESCRIPTION OF THE DRAWINGS

FIG. 1 is a functional block diagram of a driving support apparatus;

FIG. 2 is an explanatory diagram showing a traffic condition of an intersection;

FIG. 3 is an explanatory diagram showing a stationary object and a course of a vehicle;

FIG. 4 is a flowchart of a process for predicting a course of the vehicle;

FIG. 5 is a flowchart of a process for predicting a course of an oncoming vehicle; and

FIG. 6 is a flowchart of a process for determining a collision and giving a warning.

### DETAILED DESCRIPTION OF THE PREFERRED EMBODIMENTS

An embodiment of the present invention will be described with reference to the drawings. A driving support apparatus according to the present invention is mounted on a vehicle such as an automobile to support driver's driving. Even in a case where the driver is not aware of a predicted danger, the driving support apparatus warns the driver in a manner the driver can easily recognize the danger and is encouraged to recognize the danger and drive according to the warning.

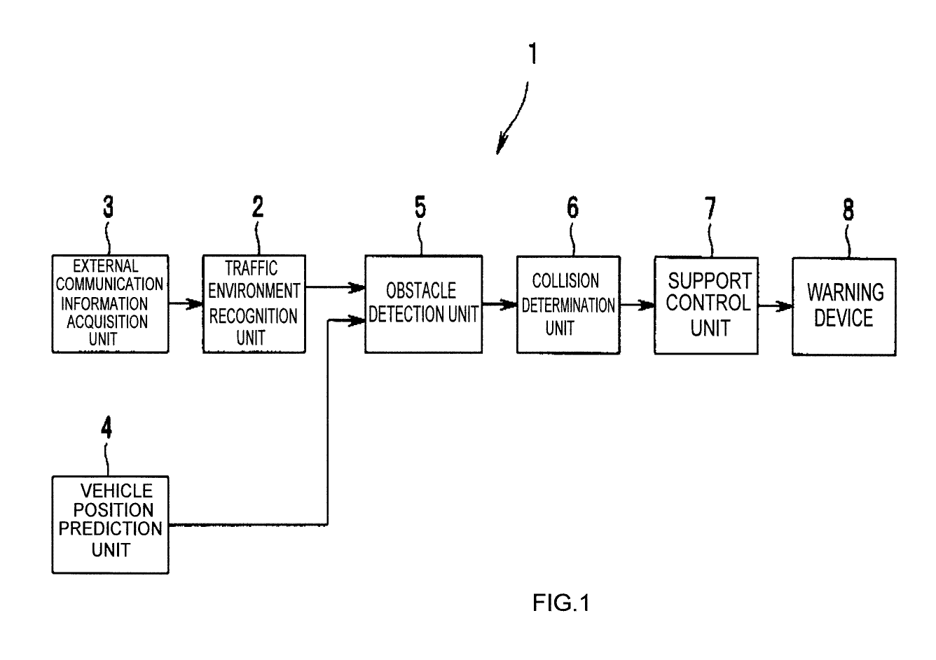

In the present embodiment, as shown in FIG. 1, a driving support apparatus 1 includes function units, as main components, of a traffic environment recognition unit 2 that recognizes a traffic environment around a vehicle such as a road environment including an intersection and the like and states of other vehicles traveling on an oncoming traffic lane and the like using an autonomous sensor such as an onboard camera and a radar, an external communication information acquisition unit 3 that acquires external traffic information via a vehicle-to-vehicle communication and a road-to-vehicle communication, a vehicle position prediction unit 4 that predicts a course of the vehicle and calculates the position of the vehicle on the predicted course, an obstacle detection unit 5 that detects a position, a predicted course and a type of an obstacle which may intersect with the predicted course of the vehicle, a collision determination unit 6 that determines a possibility of a collision between the detected obstacle and the vehicle, and a support control unit 7 that outputs a display control signal to display an optimal warning via a warning device 8 so that a driver easily recognize the collision possibility when it is determined that there is a possibility of a collision with the obstacle.

The support control unit 7 outputs a control signal to a control device (not shown) of the vehicle to instruct an automatic braking, an accident avoidance control and the like according to need. Further, the respective function units are composed of a single or plural computer units and configured to be able to exchange data one another via a communication bus which forms an in-vehicle network.

Next, the respective function units of the driving support apparatus 1 will be described. Firstly, the traffic environment recognition unit 2 processes information from a recognition sensor such as an onboard stereo camera and a millimeter wave radar or the like, vehicle position measurement information, map information, or information acquired by the external communication information acquisition unit 3 via a vehicle-to-vehicle communication or a road-to-vehicle communication for example, recognizes an obstacle in a traveling environment of the vehicle (for example, guardrails, curbs, motor cycles, ordinary-sized vehicles, heavy-duty vehicles, pedestrians or utility poles) and sends the data to the obstacle detection unit 5.

The vehicle position prediction unit 4 predicts a future course of the vehicle based on a current traffic environment in which the vehicle is traveling and a current state of the vehicle. More specifically, the vehicle position prediction unit 4 predicts a course based on a steering wheel angle and a vehicle speed when the current vehicle speed is equal to or greater than a predetermined vehicle speed, and predicts a course based on map information or the like according to blinking states of right and left indicators (turn-signal lamps) or a transmission shift position when the current vehicle speed is lower than the predetermined vehicle speed. This predicted course is approximated to a line connecting predicted positions of the vehicle which are calculated at predetermined time intervals.

The obstacle detection unit 5 has functions for calculating a position and a predicted course of an obstacle and for detecting a type of the obstacle. The obstacle detection unit 5 detects a position, a predicted course and a type of a moving object (other vehicles, motor cycles, pedestrians and the like) that may intersect with the predicted course of the vehicle and a stationary object such as a fixed structure or a vehicle parked on the course of the vehicle, as an obstacle that may intersect with the course of the vehicle, and sends the detected information to the collision determination unit 6. In this case, when the obstacle is a moving object, the obstacle detection unit 5 uses a course, as a predicted course, which is a line connecting predicted positions which are calculated at predetermined time intervals starting from the current position with an assumption that the moving object will keep moving at a current speed and to a current moving direction. Further, when the obstacle is a stationary object on the road, the obstacle detection unit 5 maintains the detected position of the stationary object.

The collision determination unit 6 determines a possibility of a collision between the vehicle and the obstacle based on information from the vehicle position prediction unit 4 and the obstacle detection unit 5. When it is determined that there is a possibility of the collision, the collision determination unit 6 instructs an execution of a driving support control via the support control unit 7. In the present embodiment, it is determined that there is a possibility of a collision between the vehicle and an obstacle when the vehicle proceeds on the predicted course and the distance between the position of the vehicle at time t and the position of the obstacle at the same time t falls within a predetermined range.

When there is a possibility of a collision between the vehicle and the obstacle, the support control unit 7 outputs a control signal to the warning device 8. Here, the control signal is for informing the driver of at least a predicted collision position where the predicted course of the vehicle intersects with the obstacle as an optimal warning display which the driver can easily recognize. According to the present embodiment, the current position, predicted course and type of the obstacle, the predicted course of the vehicle and the predicted collision position are displayed on a display of the warning device 8 and, at the predicted collision position, an icon as a visual sign for calling the driver's attention is displayed. Further, the current traffic environment around the vehicle is also displayed so that the driver can easily recognize the current state of the vehicle.

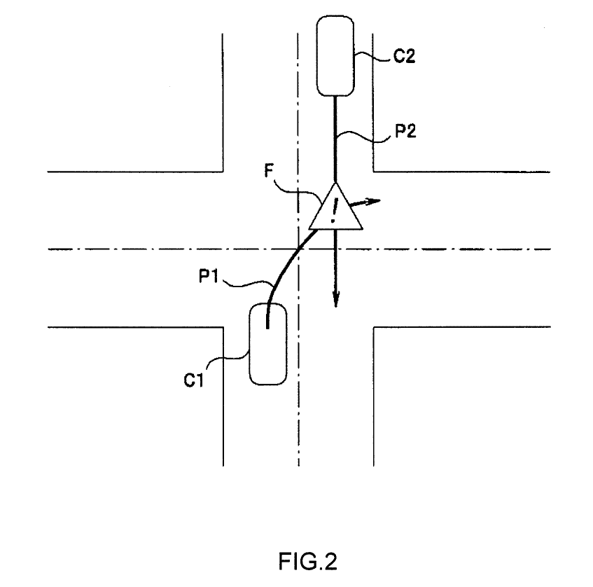

For example, as shown in FIG. 2, when a vehicle C1 makes a right turn at an intersection, the support control unit 7 functions to display on the display of the warning device 8 the intersection which is the traffic environment around the vehicle C1 and an oncoming vehicle C2 (type of the obstacle) which is to be watched for regarding the possibility of a collision with vehicle C1 at the intersection while functioning to display the respective current positions with a traveling track P1 of the vehicle C1 making a right turn and a traveling track P2 of the vehicle C2 coming into the intersection using indication arrows. Further, the support control unit 7 functions to display a predetermined icon F at the intersection (predicted collision position) of the traveling track P1 of the vehicle C1 and the traveling track P2 of the oncoming vehicle C2.

With this configuration, even in a case where the driver of the vehicle C1 does not pay sufficient attention to the oncoming vehicle C2, it is possible to allow the driver to easily and clearly recognize that there is a high possibility of a collision with the oncoming vehicle C2 if the driver starts to turn right in the current situation. As a result, the support function of the driving support apparatus 1 can work effectively so that an occurrence of an accident can be prevented and active safety performance can be improved.

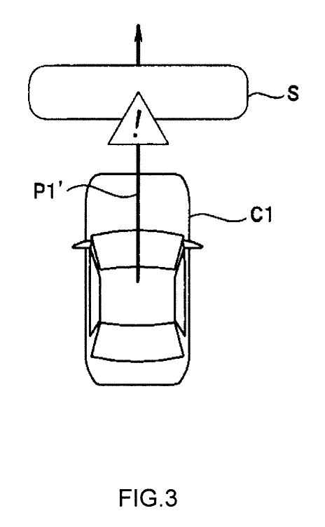

Further, the warning display controlled by the support control unit 7 can be applied to cases where a danger is assumed against a store, a house, a parked vehicle, a human or the like in addition to an oncoming vehicle. For example, as shown in FIG. 3, in a parking area, when there is a stationary object S such as a parked vehicle, a store, a house and a wall (fixed structure) in front (or rear) of the vehicle C1 and a danger of a collision caused by startup with an incorrect operation can be assumed, the support control unit 7 functions to display a traveling track P1′ of the vehicle C1 with respect to the stationary object S with an indication arrow and an icon F that indicates a collision at a position where the traveling track P1′ may intersect with the stationary object S. With this configuration, when the vehicle C1 starts to drive with the shift position of the drive range (D range) from a back-in parking lot or with the shift position of the reverse range (R range) from a head-in parking lot, the driver is clearly warned of a danger of a collision with the obstacle and this prevents an accident from occurring.

Note that, as the warning device 8, a display of a navigation device, a head-up display, a display using laser or the like can be used and a visual display and a sound output can be used in combination according to need.

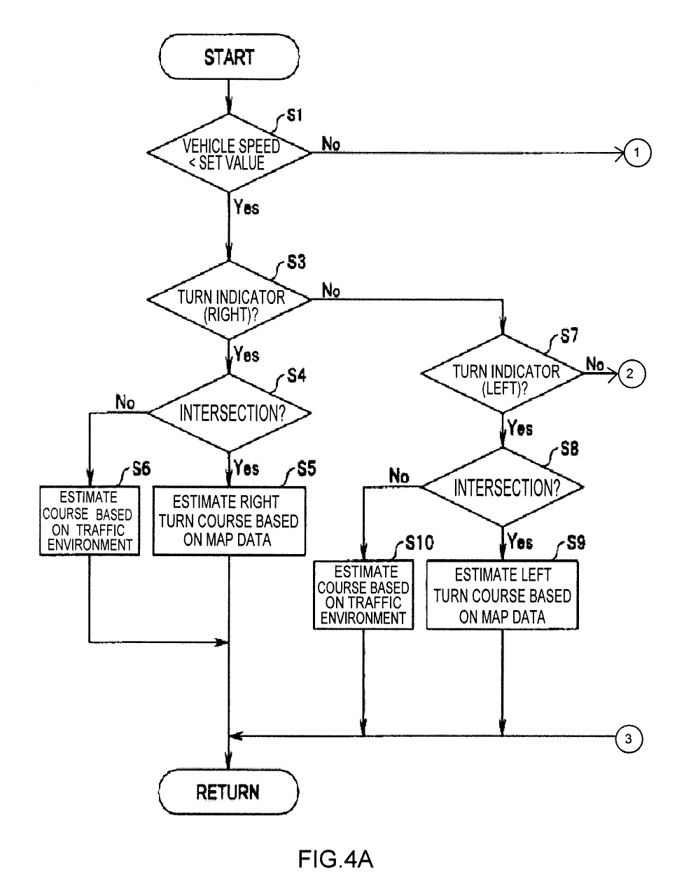

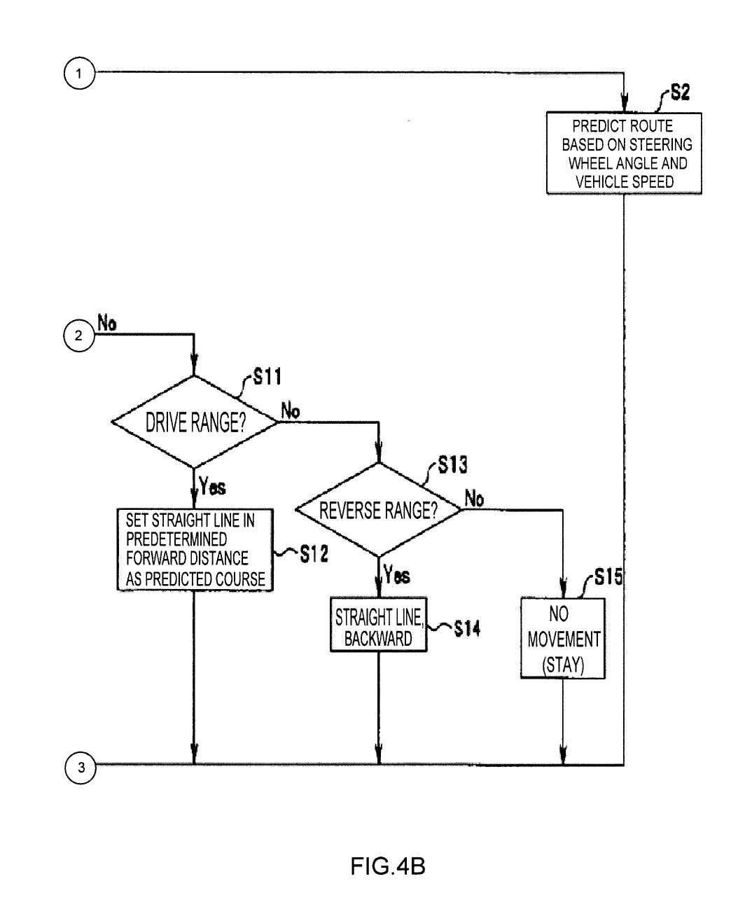

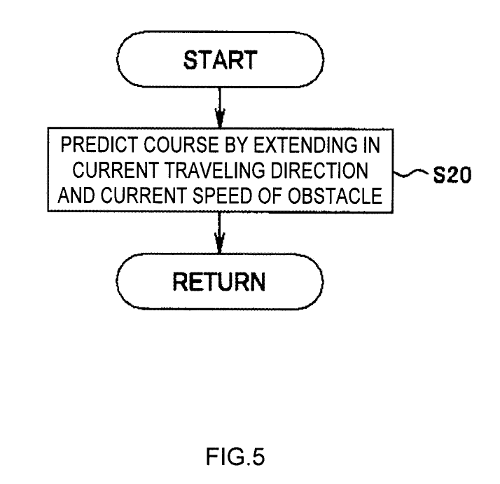

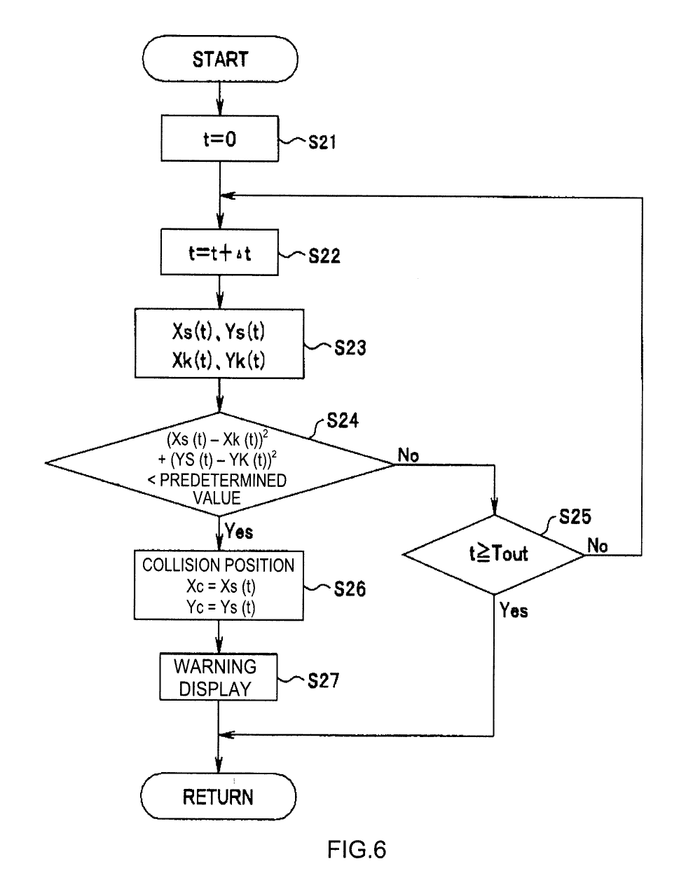

Next, a program processing according to a collision determination and warning of the driving support apparatus 1 will be described with reference to flowcharts of FIGs. 4 to 6. Note that, an example for predicting a course of the vehicle and a course of an obstacle which is a moving object and warning the driver will be described. The flowchart of FIG. 4 shows a process for predicting a course of the vehicle, the flowchart of FIG. 5 shows a process for predicting a course of the obstacle and the flowchart of FIG. 6 shows a process for determining and warning a collision.

In the process for predicting a course of the vehicle in FIG. 4, firstly in step S1, the current vehicle speed is compared with a set value. Then, when the current vehicle speed is equal to or greater than the set value, a course is predicted based on the current steering wheel angle and vehicle speed in step S2.

On the other hand, when the current vehicle speed of the vehicle is lower than the set value and it is determined that the vehicle is traveling slowly or is being stopped, the process proceeds from step S1 to step S3 and checks whether the turn indicator for the right direction is activated and blinking. When the turn indicator is for the right direction blinking, the process proceeds from step S3 to step S4 and checks whether the position of the vehicle is at an intersection.

As a result, when the vehicle is at an intersection, the process proceeds from step S4 to step S5 and estimates a right-turn course based on map data of the intersection. When the vehicle is not at an intersection and is going to make a turn to a right road at a T-junction or enter a parking area of a store or the like on the side of the oncoming traffic lane for example, the process proceeds from step S4 to step S6 and estimates a course based on the current traffic environment. For this estimation of the right-turn course in the traffic environment, map data of specific road shapes is used if available; if not available, the course is estimated by assuming a cornering track in a certain radial for example.

On the other hand, when the turn indicator for the right direction is not blinking in step S3, the process branches from step S3 to step S7 and checks whether the turn indicator for the left direction is blinking. Then, when the left turn indicator is blinking, the process proceeds from step S7 to step S8 and, in steps S8, S9 and S10, a course in the left direction is estimated in the same process as the course estimation to the right direction in steps S4, S5 and S6.

Further, when the left turn indicator is not blinking in step S7 (in other words, neither the right nor left turn indicators are blinking), the process proceeds to from step S7 to step S11 and checks whether the shift position of the transmission is in the drive range (D range). When the transmission shift position is in the D range, it is assumed that the vehicle is going to travel forward in a straight line and a straight course within a predetermined forward distance is predicted as a predicted course in step S12. When the transmission shift position is not in the D range, it is further checked whether the transmission shift position is in the reverse range (R range) in step S13.

In step S13, when the transmission shift position is in the R range, it is assumed that the vehicle is going to travel backward in a straight line and a straight course within a predetermined backward distance is predicted as a predicted course in step S14. When the transmission shift position is not in the R range, it is determined that the vehicle is not going to move (staying) in step S15 and the process ends without estimating a course.

On the other hand, as shown in step S20 of FIG. 5, the course of the obstacle is estimated by extending the current course in the current traveling direction and at the current speed. Note that, when the obstacle is a stationary object, the position of the stationary object is acquired.

After the above course estimation process is executed, a collision possibility is determined by a process shown in FIG. 6 and an warning process is executed based on the determination result. In the collision determination, a state of course prediction patterns of the vehicle and the obstacle in Δt seconds ahead of their current position of the vehicle and the obstacle are assumed and, when the positions of the vehicle and the obstacle in Δt seconds ahead become closer than a set value, it is determined there is a possibility of a collision.

More specifically, firstly in step S21 of FIG. 6, the time t at the beginning of the collision determination is initialized to “0” and, in step S22, the time t is set forward by a predetermined time length Δt (t=t+Δt). Next, in step S23, an X coordinate position Xs (t) and a Y coordinate position Ys (t) of the vehicle at the current speed at time t are calculated and an X coordinate position Xk(t) and a Y coordinate position Yk(t) of the obstacle at the current speed at time t are calculated. In this case, when the obstacle is a stationary object at speed “0”, the X coordinate position Xk(t) and the Y coordinate position Yk(t) of the obstacle maintain in the same position.

Next, the process proceeds to step S24 and checks whether the distance between the vehicle and the obstacle is within a set region where there is a possibility that the vehicle and the obstacle may contact with each other. Here, in order to reduce a calculation amount, a square value of the distance between the vehicle and the obstacle (Xs(t)−Xk(t))²+(Ys(t)−Yk(t))² is compared with a set value and it is equivalently checked whether the distance between the vehicle and the obstacle is within a set range.

If the value of (Xs(t)−Xk(t))²+(Ys(t)−Yk(t))² is equal to or greater than the set value as a result, the process proceeds from step S24 to step S25 and checks whether the time t has exceeded a set time period Tout. The set time period Tout is used to define a period of time required to determine a collision within a predetermined distance. In a case where time t is smaller than the set time period Tout, the process returns to step S22 and sets the time t forward by the time length Δt to execute the same process. If the time t is equal to or greater than the set time period Tout, it is determined that there is no possibility of a collision and the process ends.

After that, when the value of (Xs(t)−Xk (t))²+(Ys(t)−Yk(t))² is less than the set value under a condition where the time t is less than the set time period Tout, it is determined that there is a possibility of a collision. Then, the process proceeds from step S25 to step S26 and the vehicle position (Xs(t), Ys(t)) at time t is regarded as a collision position (Xc, Yc).

Then, in step S27, along with the current position and the predicted course of the vehicle, the type of the obstacle which may collide with the vehicle is displayed. In a case where the obstacle is a moving object, along with the current position and the predicted course of the moving object, a visual sign such as an icon that indicates a collision is displayed at the predicted collision position of the intersection where predicted courses of the vehicle intersects with the obstacle, in order to warn the driver. Regarding this display of warning, for example, a warning is displayed as shown in above described FIG. 2 when a collision between the vehicle and another vehicle at an intersection is determined and a warning is displayed as shown in above described FIG. 3 when a collision between the vehicle and a stationary object is determined. With this configuration, even when the driver is not aware of a future danger due to insufficient attention or an oversight, the driver is surely and easily encouraged to recognize the danger.

As described above, according to the present embodiment, a predicted danger is displayed so that a driver who does not recognize the danger can easily recognize and the driver is encouraged to recognize the danger and drive according to the warning. With this configuration, a reliable prevention of a traffic accident can be realized by encouraging the driver to realize a future danger of which the driver is not aware so that active safety performance can be improved.

Note that, in the present embodiment, as a driving support for a driver, an example has been described in which a warning is given to the driver when it is determined that there is a possibility of a collision between the vehicle and an obstacle; however, the present invention is not limited to this configuration and a deceleration or prevention of starting by an automatic brake, or further, automatic steering control may be executed at the same time as the warning is given, for example.

What is claimed is:

1. A vehicular driving support apparatus for recognizing an environment around a vehicle and performing a driving support for a driver, comprising:
a vehicle position prediction unit configured to predict a course of the vehicle and calculate a position of the vehicle on the predicted course;
an obstacle detection unit configured to detect an obstacle that may intersect with the predicted course of the vehicle and calculate a position of the obstacle;
a collision determination unit configured to determine a possibility of a collision between the vehicle and the obstacle based on the position of the vehicle on the predicted course and the position of the obstacle; and
a support control unit configured to, when it is determined that there is a possibility of a collision between the vehicle and the obstacle, output a control signal to inform the driver of at least a predicted collision position where the predicted course of the vehicle intersects with the obstacle.

2. The vehicular driving support apparatus according to claim 1, wherein
the support control unit outputs a control signal to display a current position and a type of the obstacle, the predicted course of the vehicle and the predicted collision position on a display.

3. The vehicular driving support apparatus according to claim 2, wherein
the support control unit controls to display a visual sign at the predicted collision position to call the driver's attention.

4. The vehicular driving support apparatus according to claim 2, wherein
the support control unit further functions to display a current traffic environment around the vehicle.

5. The vehicular driving support apparatus according to claim 1, wherein
the obstacle detection unit detects the obstacle whether it is a moving object or a stationary object.
